(19) United States
(12) Patent Application Publication
(10) Pub. No.: US 2024/0021357 A1
(43) Pub. Date: Jan. 18, 2024

(54) INDUCTIVE COIL BRACKETS

(71) Applicant: Hewlett-Packard Development Company, L.P., Spring, TX (US)

(72) Inventor: Charles Cody Gerhardt, Amelia, OH (US)

(73) Assignee: Hewlett-Packard Development Company, L.P., Spring, TX (US)

(21) Appl. No.: 17/867,330

(22) Filed: Jul. 18, 2022

(51) Int. Cl. H01F 27/30

(52) U.S. Cl. CPC H01F 27/306

(57) ABSTRACT

In some examples, a bracket includes mounting holes disposed in a rectangular pattern. In some examples, the mounting holes permit passage of mounting fasteners to mount an electronic device to the bracket. In some examples, the bracket includes an inductive coil. In some examples, the inductive coil provides a magnetic field to the electronic device.

### BACKGROUND

Some electronic devices include electronic circuitry for performing processing. As processing capabilities have expanded, electronic devices have been utilized to perform more functions. For example, a variety of electronic devices are used for work, communication, and entertainment. Electronic devices may be powered by sources of electricity.

### BRIEF DESCRIPTION OF THE DRAWINGS

FIG. 1 is a diagram illustrating an example of a bracket;

FIG. 2 is a diagram illustrating an example of a bracket;

FIG. 3 is a diagram illustrating a perspective view of an example of a bracket;

FIG. 4 is a diagram illustrating a perspective view of an example of a bracket; and

FIG. 5 is a diagram illustrating a perspective view of an example of a bracket.

### DETAILED DESCRIPTION

A bracket is a structure to attach to an object and/or to support an object. For example, an electronic device may be mounted to a bracket to support (e.g., hold) the electronic device in a location. In some examples, a bracket may be utilized to attach an electronic device to a ceiling, wall, floor, support base (e.g., foot), furniture, cart, vehicle, etc. For instance, a television may be attached to a wall by a bracket, a monitor may be attached to a support base (e.g., foot) by a bracket, a monitor may be attached to a desk by a bracket, etc. A bracket may be fabricated from metal(s), plastic(s), organic material(s), and/or another material(s).

An inductive coil is a conductive coil (e.g., coil of metal wire, copper wire, etc.) capable of producing a magnetic field. For instance, when a current (e.g., direct current (DC) or alternating current (AC)) is passed through an inductive coil, the inductive coil may produce a magnetic field around the inductive coil. If a conductor (e.g., wire, another coil, metal, etc.) is disposed in the magnetic field, the magnetic field may induce a current in the conductor. Accordingly, an inductive coil may be utilized to transfer electrical power to another coil via magnetic induction. For instance, the electrical power may be transferred wirelessly, without direct electrical contact between the inductive coil (e.g., transmitter) and the other coil (e.g., receiver). The transferred electrical power may be utilized to power a device. Some examples of the brackets described herein may include an inductive coil to power an attached electronic device.

Throughout the drawings, similar reference numbers may designate similar or identical elements. When an element is referred to without a reference number, this may refer to the element generally, with and/or without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

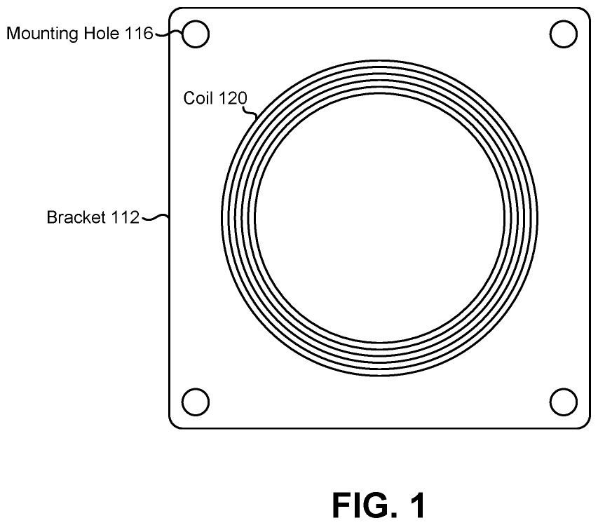

FIG. 1 is a diagram illustrating an example of a bracket 112. The bracket 112 includes mounting holes (e.g., mounting hole 116) disposed in a rectangular pattern. For instance, mounting holes disposed in a rectangular pattern are mounting holes located at the corners (e.g., four corners) of a rectangular shape. For instance, a mounting hole may be centered at each corner of a rectangle shape. A mounting hole is an opening or passage through a bracket to attach the bracket. In some examples, mounting holes may permit passage of mounting fasteners to mount an electronic device to a bracket. For instance, the mounting hole 116 may permit a fastener (e.g., screw, nail, rivet, stud, anchor, etc.) to pass through the bracket 112 and to hold (e.g., mount) an object (e.g., electronic device) to the bracket 112. In some examples, additional hardware (e.g., washer(s), rubber spacer(s), and/or nut(s), etc.) may be utilized with a mounting fastener.

An electronic device is a device that includes electronic circuitry (e.g., integrated circuitry, a chip(s), etc.). Examples of electronic devices may include monitors, televisions, display devices, display panels, computing devices, game consoles, etc. Some examples of electronic devices may utilize circuitry (e.g., controller(s) and/or processor(s), etc.) to perform an operation or operations. In some examples, electronic devices may execute instructions stored in memory to perform the operation(s). Instructions may be code and/or programming that specifies functionality or operation of the circuitry. In some examples, instructions may be stored in memory (e.g., Random-Access Memory (RAM), Read-Only Memory (ROM), Erasable Programmable Read-Only Memory (EPROM), Electrically Erasable Programmable Read-Only Memory (EEPROM), flash memory, dynamic random-access memory (DRAM), synchronous DRAM (SDRAM), magnetoresistive random-access memory (MRAM), phase-change random-access memory (PCRAM), hard disk drive (HDD), solid state drive (SSD), optical drive, etc.).

In some examples, the mounting holes may conform to a Video Electronics Standards Association (VESA) profile (e.g., VESA Mounting Interface Standard (MIS), VESA MIS-D, VESA MIS-E, VESA MIS-F, etc.). A VESA profile indicates a distance(s) between holes (e.g., mounting holes, threaded holes in an electronic device, etc.). Examples of VESA profiles include (in horizontal distance×vertical distance in millimeters (mm)): 75×75, 100×100, 200×200, 300×300, 400×400, 1000×800, 800×600, 800×400, 700×400, 300×200, 400×200, 200×100, 400×300, 600×200, 600×400, etc.

A mounting fastener is a fastener to mechanically hold objects (e.g., the bracket 112 and an electronic device) together. As used herein a “screw” may denote a fastener with threads (e.g., spiral groove, helical groove, etc.) disposed along a dimension of the fastener. For instance, a “screw” may denote a threaded cylindrical fastener without a pointed end (e.g., a bolt) and/or a threaded fastener with a pointed end (e.g., a tapered end). In some examples, a screw includes a threaded portion along a rotational axis and a head that is larger than the threaded portion in a direction perpendicular to the rotational axis. For instance, a threaded portion of a screw may be sized to pass through the mounting hole 116 and the head may be sized to not pass through the mounting hole 116 (e.g., to hold the bracket 112 against an object that the screw is disposed within). A mounting hole may be circular, square, hexagonal, etc., or may have another shape.

In some examples, a mounting fastener may be utilized to mount an electronic device to a bracket semi-permanently or permanently. For instance, a mounting fastener may disallow (e.g., prevent, restrict, etc.) unmounting without removal of the mounting fastener. For example, an electronic device (e.g., monitor, television, computer, etc.) may not be unmounted from the bracket 112 without removing each mounting fastener(s) attached to the electronic device through the bracket 112. In some examples, when an object is mounted to the bracket 112, the bracket 112 may not facilitate removal of the object and/or detachment of the object from the bracket 112 without fastener removal. For instance, the bracket 112 may not include a magnetic mount(s) (for temporary attachment and/or detachment, for example).

The bracket 112 may include an inductive coil 120. The inductive coil 120 may be utilized to provide a magnetic field to an electronic device. For instance, the inductive coil 120 may provide a magnetic field to an electronic device that is mounted to the bracket 112, when an electric current is provided to the inductive coil 120. In some examples, the bracket 112 may include a power interface to receive power from a power source. For instance, the bracket 112 may include circuitry to receive power via a power cord from mains electricity (e.g., a wall socket), from a Universal Serial Bus (USB) cable (e.g., USB-C cable), etc.

When the bracket 112 is mounted to an electronic device, the inductive coil 120 may be held within a distance from a corresponding coil (e.g., receiver coil) of the electronic device (which may enable powering the electronic device, for example). In some examples, the inductive coil 120 may be covered with (or embedded in) a nonconductive (e.g., dielectric) material. For instance, the inductive coil 120 may be covered by plastic (e.g., a plastic housing).

In some examples, the bracket 112 may include a mounting plate that includes the mounting holes. For instance, a mounting plate may be a structure (e.g., metal plate, plastic plate, etc.) in which the mounting holes are formed. In some examples, the inductive coil 120 may be attached to the mounting plate.

In some examples, the inductive coil 120 may protrude from a surface (e.g., plane, mounting plate, etc.) of the bracket 112 where the mounting holes 116 are disposed. In some examples, a face of the inductive coil 120 (and/or inductive coil cover) may be flush with a surface (e.g., plane, mounting plate, etc.) of the bracket 112 where the mounting holes 116 are disposed. In some examples, the inductive coil 120 may be recessed from a surface (e.g., plane, mounting plate, etc.) of the bracket 112 where the mounting holes 116 are disposed. For instance, the bracket 112 may include a mounting plate that includes the mounting holes, where the inductive coil 120 is disposed within the mounting plate (e.g., below an outer surface of the mounting plate). In some examples, a face of the inductive coil 120 or a cover thereof may contact an object (e.g., electronic device) when the object is mounted to the bracket 112.

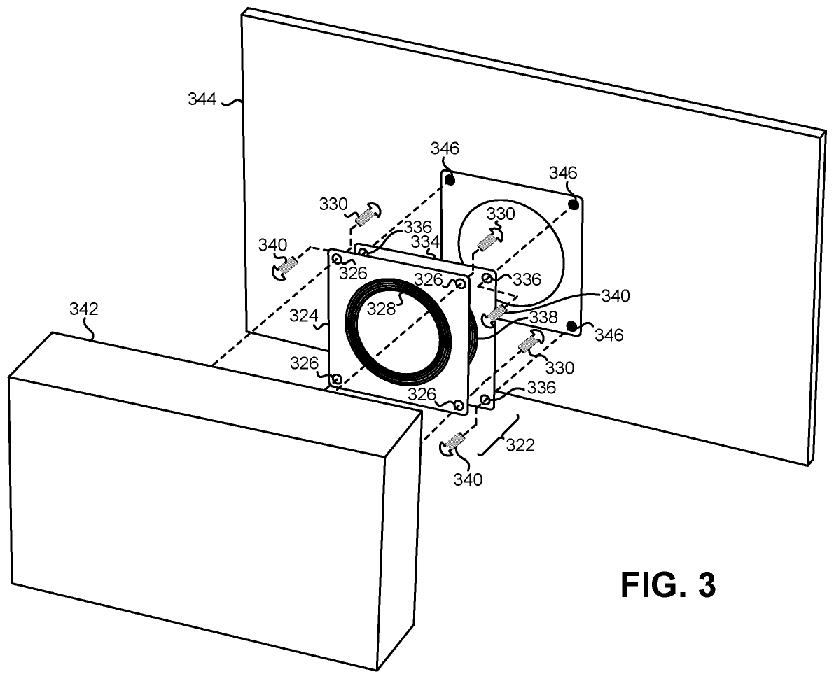

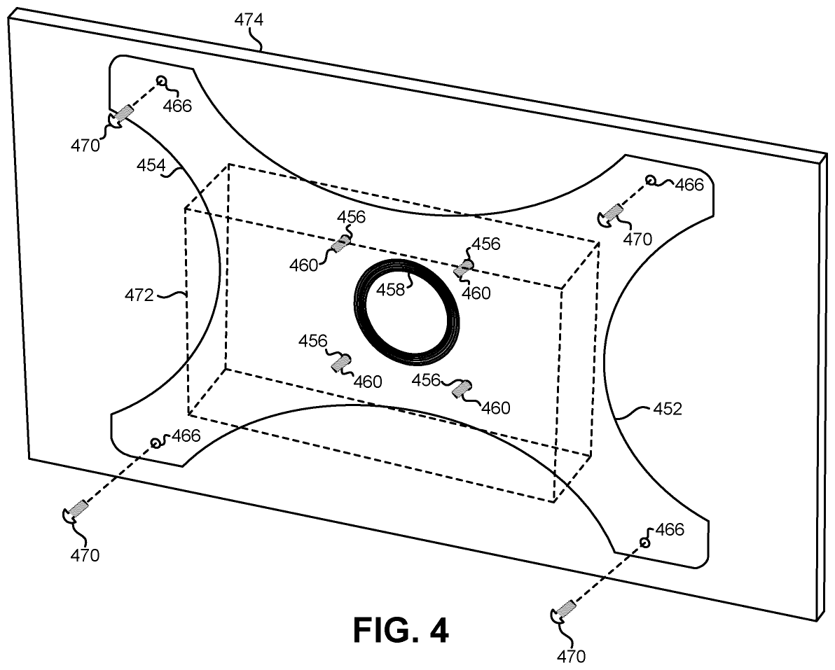

In some examples, the bracket 112 may support multiple objects. For instance, the bracket 112 may support a second electronic device. In some examples, a first electronic device may be mounted to a first side (e.g., face, front side, etc.) of the bracket 112 and a second electronic device may be mounted to a second side (e.g., rear, back side, etc.) of the bracket 112. FIG. 3 and FIG. 4 provide examples of brackets to mount two electronic devices.

In some examples, the bracket 112 may include second mounting holes. In some examples, mounting fasteners (e.g., screws) may be disposed in a first direction through the mounting holes to mount an electronic device, and second mounting fasteners may be disposed in a second direction through the second mounting holes to mount the second electronic device. For instance, the second mounting fasteners may be disposed in a second direction opposite from the first direction through the second mounting holes to mount the second electronic device. For example, mounting fasteners may be disposed from a front through a back of the bracket 112 and second mounting fasteners may be disposed from the back through the front of the bracket 112.

In some examples, the bracket 112 may provide the magnetic field to a first electronic device and a second electronic device. For instance, the bracket 112 may produce a magnetic field(s) to a front side and to a back side of the bracket 112 to the first electronic device and the second electronic device. In some examples, the bracket 112 may include a second inductive coil to provide a second magnetic field to the second electronic device.

In some examples, the first electronic device may be a computer and/or the second electronic device may be a display device (e.g., monitor, television, etc.). For instance, the first electronic device may be a desktop computer and the second electronic device may be a monitor (e.g., light emitting diode-liquid crystal display (LED-LCD) monitor, organic light emitting diode (OLED) monitor, etc.).

In some examples, the computer and display device may be associated. For instance, the computer may be linked to the display device with a wired or wireless link. For instance, the computer may send image data to the display device over the wired or wireless link.

In some examples, an electronic device may be linked to another electronic device or devices using a wired link. For example, an electronic device (e.g., display device, monitor, television, computing device, etc.) may include a wired communication interface (e.g., connector or connectors) for connecting electronic devices. Connectors are structures that enable forming a physical and/or electrical connection. For instance, a connector may be a port, plug, and/or electrical interface, etc. A connector or connectors may allow electronic devices to be connected with a cable or cables. Examples of connectors include DisplayPort™ (DP) connectors, High-Definition Multimedia Interface (HDMI®) connectors, Universal Serial Bus (USB) connectors, Lightning® connectors, Digital Visual Interface (DVI) connectors, optical-copper link (OCuLink) connectors, Ethernet connectors, etc.

In some examples, an electronic device may be linked to another electronic device with a wireless link. For instance, an electronic device (e.g., display device, monitor, television, computing device, etc.) may include a wireless communication interface to send and/or receive wireless (e.g., radio frequency (RF)) signals. Examples of wireless communication interfaces may include an Institute of Electrical and Electronics Engineers (IEEE®) 802.11 (WI-Fi®) interfaces, Bluetooth® interfaces, cellular (e.g., 3G, Long-Term Evolution (LTE®), 4G, 5G, etc.) interfaces, etc.

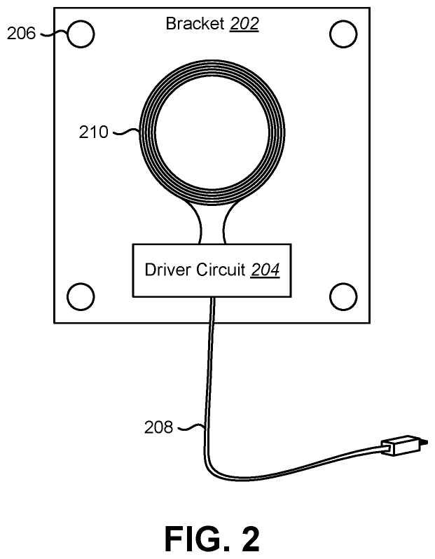

FIG. 2 is a diagram illustrating an example of a bracket 202. The bracket 202 may be an example of the bracket 112 described in relation to FIG. 1. For instance, the bracket 202 may include mounting holes (e.g., mounting hole 206) and an inductive coil 210.

In the example of FIG. 2, the bracket 202 includes a driver circuit 204. The driver circuit 204 is circuitry (e.g., an integrated circuit) to supply a current to the inductive coil 210 and/or to control the inductive coil 210. In some examples, the driver circuit 204 may include a pulse generator(s), transistor(s), resistor(s), capacitor(s), voltage regulator(s), controller(s) and/or memory(ies). A controller may be a logic circuit (e.g., microprocessor, field-programmable gate array (FPGA), application-specific integrated circuit (ASIC), etc.) to control an amount of current supplied to the coil 210 (e.g., an amount of power transmitted). For instance, different devices may utilize different power profiles (e.g., may target an amount of power to receive, may target a modulation of the magnetic field supplied by the inductive coil 210, etc.). In some examples, the bracket 202 (e.g., driver circuit 204, controller, etc.) may communicate with an electronic device (e.g., receiver) by detecting a signal pattern and/or modulation in response to a supplied magnetic field, and/or through wireless signaling (e.g., Bluetooth). The controller may select a power profile based on the communication.

In some examples, the driver circuit 204 may supply currents to multiple inductive coils and/or may control multiple inductive coils (to power multiple electronic devices, for instance). In some examples, the bracket 202 may include multiple driver circuits. For instance, each driver circuit may correspond to a respective power coil, may supply a current to a respective power coil, and/or may control a respective power coil (to power respective electronic devices, for instance).

In some examples, the driver circuit 204 may include a power interface to receive power from a power source. For instance, the driver circuit 204 may be coupled to a wire(s) of a power cable 208 and/or may include a jack for coupling with a power cable 208. In some examples, the power cable 208 may provide electrical power from a power source (e.g., mains electricity, wall socket, USB-C port, Power over Ethernet (PoE), etc.). The driver circuit 204 may regulate the current provided to the inductive coil 210 from the power cable 208.

In some examples, the bracket 202 (e.g., driver circuit(s)) may include multiple power interfaces to receive power from a power source(s). For instance, the bracket (e.g., driver circuit(s)) may be coupled to a wire(s) of power cables and/or may include jacks for coupling with power cables (including power cable 208, for instance). In some examples, the power cables may provide electrical power from a power source(s) (e.g., mains electricity, wall socket(s), USB-C port(s), etc.). The bracket 202 (e.g., driver circuit(s)) may regulate the current provided to the inductive coil(s) from the power cables.

FIG. 3 is a diagram illustrating a perspective view of an example of a bracket 322. The bracket 322 may be an example of the bracket 112 described in relation to FIG. 1 and/or an example of the bracket 202 described in relation to FIG. 2. In the example of FIG. 3, the bracket 322 includes a first mounting plate 324 and a second mounting plate 334.

The first mounting plate 324 may include first mounting holes 326 disposed in a first rectangular pattern to permit passage of first mounting screws 330 to mount a first electronic device 342 to a first side of the bracket 322. The second mounting plate 334 may include second mounting holes 336 disposed in a second rectangular pattern to permit passage of second mounting screws 340 to mount a second electronic device 344 to a second side of the bracket 322. In some examples, the first side and the second side are outer opposite sides of the bracket 322.

The bracket 322 may include an inductive coil 328 to provide a magnetic field to the first electronic device 342. In some examples, the bracket 322 may include a second inductive coil 338 to provide a second magnetic field to the second electronic device 344. For instance, the bracket 322 may include a first power interface to provide power (e.g., first power) to the inductive coil 328 and a second power interface to provide power (e.g., second power) to the second inductive coil 338. In some examples, utilizing separate inductive coils for separate devices may enable utilization of different power profiles for the separate devices. In some examples, the bracket 322 may include an electromagnetic barrier between inductive coils. For instance, the bracket 322 may include ferromagnetic material (e.g., metallic plate, cage, etc.) between the inductive coil 328 and the second inductive coil 338. The electromagnetic barrier may reduce (e.g., attenuate, prevent, etc.) cross-bleed between the magnetic field and the second magnetic field.

In the example of FIG. 3, the first electronic device 342 may be a computing device (e.g., a desktop computer including a receiver coil to receive power from the inductive coil 328), and the second electronic device 344 may be a display device (e.g., a monitor including a receiver coil to receive power from the second inductive coil 338).

The first electronic device 342 and/or the second electronic device 344 may include fastener holes (e.g., threaded holes) to receive and/or hold to mounting screws. For instance, the second electronic device 344 may include second fastener holes 346 to receive and/or hold to the second mounting screws 340. In some examples, the bracket 322 may include a mounting structure (e.g., arm(s), attachment(s), support(s), brace(s), etc.) to attach the bracket to a support object. Examples of a support object include a wall, ceiling, base, foot, cart, etc.

FIG. 4 is a diagram illustrating a perspective view of an example of a bracket 452. The bracket 452 may be an example of the bracket 112 described in relation to FIG. 1 and/or an example of the bracket 202 described in relation to FIG. 2. In the example of FIG. 4, the bracket 452 includes a mounting plate 454.

The mounting plate 454 may include first mounting holes 456 disposed in a first rectangular pattern to permit passage of first mounting screws 460 to mount a first electronic device 472 to a first side of the bracket 452. The mounting plate 454 may include second mounting holes 466 disposed in a second rectangular pattern to permit passage of second mounting screws 470 to mount a second electronic device 474 to a second side of the bracket 452. In some examples, the first side and the second side are outer opposite sides of the bracket 452. In some examples, the first mounting screws 460 may be disposed in an opposite direction from the second mounting screws 470.

In some examples, a first spacing (e.g., inter-hole distance) of the first mounting holes 456 is different from a second spacing (e.g., inter-hole distance) of the second mounting holes 456 in a dimension(s). For instance, a first spacing of the first mounting holes 460 may be 100×100 mm and a second spacing of the second mounting holes 466 may be 400×300 mm. In some examples, the first mounting holes 456 may conform to a first VESA profile and the second mounting holes 466 may conform to a second VESA profile that is different from the first VESA profile.

The bracket 452 may include an inductive coil 458 to provide a magnetic field to the first electronic device 472 and to the second electronic device 474. For instance, the inductive coil 458 may supply a magnetic field to power the first electronic device 472 and the second electronic device 474. In some examples, utilizing one inductive coil for separate devices may provide lower material costs and/or may enable a more compact design. In the example of FIG. 4, the first electronic device 472 may be a computing device (e.g., a desktop computer including a receiver coil to receive power from the inductive coil 458), and the second electronic device 474 may be a display device (e.g., a monitor including a receiver coil to receive power from the inductive coil 458).

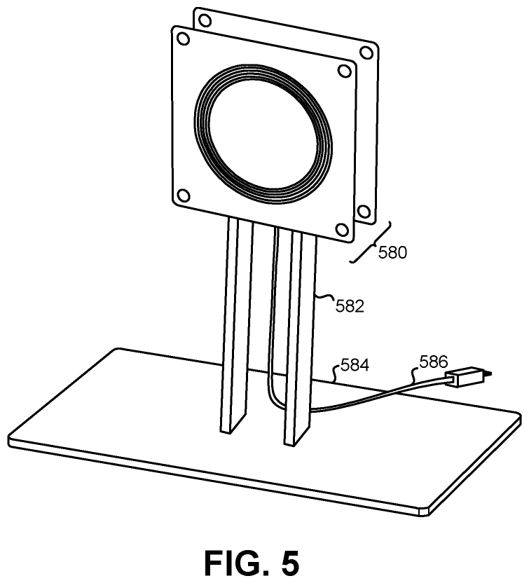

FIG. 5 is a diagram illustrating a perspective view of an example of a bracket 580. The bracket 580 may be an example of the bracket 112 described in relation to FIG. 1, the bracket 202 described in relation to FIG. 2, and/or the bracket 322 described in relation to FIG. 3. In the example of FIG. 5, the bracket 580 includes a mounting structure 582 (e.g., arm) to attach the bracket 580 to a support object 584 (e.g., a foot). The example of FIG. 5 also illustrates an example of a power cord 586 to provide power to the bracket 580. In some examples, the bracket 580 may allow swivel, tilt, rotation, height, and/or other adjustment of an electronic device(s) mounted to the bracket 580. For instance, each mounting plate may allow swivel, tilt, rotation, height, and/or other adjustment of an electronic device(s).

Some examples of the brackets described herein may provide inductive power to an electronic device(s) (e.g., monitor, desktop computer, thin client, etc.). For instance, a bracket may provide inductive power to an electronic device when the electronic device is a standalone device or when multiple electronic devices are mounted (e.g., when the bracket is wedged between the electronic devices).

In some examples, a bracket may provide power through an inductive field to a computing device (e.g., desktop computer) and a display device (e.g., monitor) when the computing device and display device are mounted together. For instance, the computing device and the display device may include separate inductive receivers to receive the power. Some examples of the techniques described herein may streamline power provisioning for bracket-mounted electronic devices (e.g., televisions). In some examples, wattage provided by the bracket may be adjustable based on the mounted devices (e.g., mounted device total power draw).

Some examples of the brackets described herein may provide semi-permanent attachment. Some examples of the brackets may not provide quick attachment and/or detachment. For instance, some examples of the brackets may not include a mounting magnet(s). Some examples of the brackets described herein may not be utilized for mobile devices (e.g., may not be utilized for wireless battery charging and/or may not be utilized for smartphone, tablet, or watch charging). In some examples, an electronic device(s) mounted to a bracket may not include a main battery (e.g., may include a clock battery and/or complementary metal oxide semiconductor (CMOS) battery without a main power battery). In some examples, an electronic device(s) mounted to a bracket may not include a rechargeable battery (e.g., may be a relatively stationary device, a non-mobile device, etc.). Some examples of the brackets described herein may reduce (e.g., obviate) the use of a power cord(s) to an electronic device(s). For instance, electrical power may be provided by a bracket to a computing device and a display device such that the computing device and the display device may not use power cords (e.g., may not use respective power cords).

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be within the scope of the disclosure. For example, aspects or elements of the examples described herein may be omitted or combined.

What is claimed is:

1. A bracket, comprising:
mounting holes disposed in a rectangular pattern to permit passage of mounting fasteners to mount an electronic device to the bracket; and
an inductive coil to provide a magnetic field to the electronic device.

2. The bracket of claim 1, wherein the mounting holes conform to a Video Electronics Standards Association (VESA) profile.

3. The bracket of claim 1, wherein the bracket is to support a second electronic device.

4. The bracket of claim 3, further comprising second mounting holes, wherein the mounting fasteners are to be disposed in a first direction through the mounting holes to mount the electronic device, and wherein second mounting fasteners are to be disposed in a second direction opposite from the first direction through the second mounting holes to mount the second electronic device.

5. The bracket of claim 3, wherein the bracket is to provide the magnetic field to the electronic device and to the second electronic device.

6. The bracket of claim 3, wherein the electronic device is a computer and the second electronic device is a display device.

7. The bracket of claim 3, wherein the bracket comprises a second inductive coil to provide a second magnetic field to the second electronic device.

8. The bracket of claim 1, wherein the bracket comprises a mounting plate that includes the mounting holes, and wherein the inductive coil is attached to the mounting plate.

9. The bracket of claim 1, wherein the bracket comprises a mounting plate that includes the mounting holes, and wherein the inductive coil is disposed within the mounting plate.

10. The bracket of claim 1, further comprising a power interface to receive power from a power source.

11. A bracket, comprising:
a first mounting plate comprising first mounting holes disposed in a first rectangular pattern to permit passage of first mounting screws to mount a first electronic device to a first side of the bracket;
a second mounting plate comprising second mounting holes disposed in a second rectangular pattern to permit passage of second mounting screws to mount a second electronic device to a second side of the bracket; and
an inductive coil to provide a magnetic field to the first electronic device.

12. The bracket of claim 11, wherein the first side and the second side are outer opposite sides of the bracket.

13. The bracket of claim 11, further comprising a mounting structure to attach the bracket to a support object.

14. The bracket of claim 11, wherein the bracket comprises a second inductive coil to provide a second magnetic field to the second electronic device.

15. The bracket of claim 14, further comprising a first power interface to provide first power to the inductive coil and a second power interface to provide second power to the second inductive coil.

16. A bracket, comprising:
a mounting plate comprising first mounting holes disposed in a first rectangular pattern to permit passage of first mounting screws to mount a first electronic device to a first side of the bracket and second mounting holes disposed in a second rectangular pattern to permit passage of second mounting screws to mount a second electronic device to a second side of the bracket; and
an inductive coil to provide a magnetic field to the first electronic device and to the second electronic device.

17. The bracket of claim 16, wherein a first spacing of the first mounting holes is different from a second spacing of the second mounting holes in a dimension.

18. The bracket of claim 16, wherein the first mounting holes conform to a first Video Electronics Standards Association (VESA) profile and the second mounting holes conform to a second VESA profile that is different from the first VESA profile.

19. The bracket of claim 16, wherein the first mounting screws are to be disposed in an opposite direction from the second mounting screws.

20. The bracket of claim 16, wherein the first electronic device is a computing device and the second electronic device is a display device.
